(19) United States
(12) Patent Application Publication
(10) Pub. No.: US 2006/0229989 A1
(43) Pub. Date: Oct. 12, 2006

(54) Valuating rights for 2nd hand trade

(75) Inventor: Wilhelmus Franciscu Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philipls Electronics N.V.

(21) Appl. No.: 10/556,519

(22) PCT Filed: May 12, 2004
(86) PCT No.: PCT/IB04/50647

§ 371 Date: Nov. 14, 2005

(30) Foreign Application Priority Data
May 16, 2003 (EP) 03101372.5

(51) Int. Cl. G06Q 99/00

(52) U.S. Cl. 705/50

(57) ABSTRACT

The present invention relates to a method, a system and a computer-readable medium storing computer-executable components for distribution of digital rights. The idea of the invention is to attach a trading value of a certain magnitude to a digital right to be distributed. The digital right is associated with a digital content bought by a consumer at the provider. The trading value of the digital right thus specifies the value of the digital content when trading the digital content for another digital content. The inventive idea is advantageous since, in prior art DRM systems, there is no trading value attached to copyrighted digital content once a provider has sold it to a consumer. By attaching a trading value to the sold digital content, the content can later easily be traded under supervision of an appropriate DRM system.

The present invention relates to a method, a system and a computer-readable medium storing computer-executable components for distribution of digital rights.

In today's information society, the rapid spread of digital information has given birth to the concept of digital rights management (DRM). This concept is used to protect the rights of a creator of the digital information, typically called the digital content, as well as the rights of an information provider distributing the information or content. This concept is applicable to information distributed via any type of media, such as the Internet, a CD, a DVD or the like. It is also applicable to any type of digital information, for example audio, video, text etc. DRM technologies are thus used to protect copyrighted content from being pirated, misused and/or wrongly distributed.

Information can be distributed between a number of actors. The distribution can, for example, take place between a server and a stand-alone computer, between two or more stand-alone computers, between a mobile phone and a computer etc. The actual information distribution can attain many different forms; information is downloaded for permanent storage on a hard disk, information is streamed from a server, whereby permanent storage of the information is disabled, a single information copy is distributed, a large number of copies are distributed etc. As clearly can be seen, there are many aspects to consider when designing DRM systems.

With the digital information stored on a media such as CD or DVD, there exists a second hand market; it is, for example, possible to walk into a second hand record shop and trade your CD or vinyl audio carrier for another audio carrier. For trading of second hand audio or video which to its nature is not associated with any media, the situation is different. The trading of locally generated copies of digital audio is certainly common, e.g. via Napster and its successors, but it is illegal. The trading of this type of copyrighted digital information via, for example, the Internet is not encouraged by the music industry, mainly because the industry cannot see how this can benefit them. Content providers consider trading of copyrighted digital information as a major threat to their revenue stream and therefore, they try to prevent the transfer of digital content from one user to another. As a result, operations relating to the duplication and distribution of digital content is restricted, and the users will try to circumvent the restrictions even though it is illegal.

Today, there is only one common legal way to trade copyrighted digital content and that is the selling of content by a creator of copyrighted content, or a content distributor, to a customer. It is desirable to have, for exchange of digital content between consumers, a system that is welcomed by the users and beneficial for the content providers, thus creating to the extent possible a win-win situation for the consumers and the content providers.

US patent application publication 2002/0065732 discloses a method of distributing electronic content involving transmitting license data with the content. The license data includes status information indicative of whether the license is a full license for content purchased from a content distributor, or temporary for content passed from a full license owner to a new consumer who has not yet paid for the content. Content is transmitted from one consumer to another, for example by PDA wireless transmission, with appropriate license status data. Connection of a PDA, on which content having only temporary license status is stored, to the Internet automatically activates a content management program on the PDA to connect to the content distributor and transmit all stored license status information. Detection of temporary licenses by the content distributor triggers a request for payment of the content, and payment results in transmission of replacement license data having a full license status back to the consumer. Upon receipt of payment, a reward is sent from the distributor to the person who transmitted the content (thus creating the temporary license) to another consumer, as a kind of sale commission.

A problem with US patent application publication 2002/0065732 is that even though the method disclosed describes content and license distribution following a type of super distribution scheme, it does not offer any possibility for consumers of copyrighted digital content to directly exchange the copyrighted content, which content they are authorized to access, with each other.

An object of the present invention is to provide a system and a method which enables exchange of copyrighted digital content between authorized consumers in such a way that the exchange is beneficial for the content providers, and still acceptable for the consumers in terms of the degree of freedom they are given in trading of the content.

This object is achieved by a method for distribution of digital rights according to claim 1, a system for distribution of digital rights according to claim 8 and a computer-readable medium storing computer-executable components for distribution of digital rights according to claim 15. Preferred embodiments are defined by the dependent claims.

According to a first aspect of the invention, a method is provided in which a trading value of a first magnitude is assigned to a first digital right to be distributed. The first digital right is associated with a first digital content, wherein the trading value specifies the value of the first digital when said first digital content is to be traded for another digital content. The first digital right is thereafter distributed.

According to a second aspect of the invention, a system is provided in which means are arranged to assign a trading value of a first magnitude to a first digital right to be distributed. Further, means are arranged to associate the first digital right with a first digital content, wherein the trading value specifies the value of the first digital when said first digital content is to be traded for another digital content. Thereafter, means are arranged to distribute the first digital right.

The idea of the invention is to attach a trading value of a certain magnitude to a digital right to be distributed. The trading value is determined by the creator of the copyrighted digital content and/or the content provider. Moreover, the digital right is created by, or by authorization of, the content creator or the content provider. The digital right is associated with a digital content bought by a consumer at the provider. The trading value of the digital right thus specifies the value of the digital content when trading the digital content for another digital content. A first content held by a first consumer can be traded for a second content held by a second consumer, the second content having a valid digital right associated to it, on condition that the trading value of the first right meets the trading value of the second right. By means of the trading value, the content provider sanctions the trade of one digital content for another for consumers holding a valid digital right.

The inventive idea is advantageous since, in prior art DRM systems, there is no trading value attached to copyrighted digital content once a provider has sold it to a consumer. By attaching a trading value to the sold digital content, the content can later easily be traded under supervision of an appropriate DRM system. The DRM system will control the transfer of rights and content to make sure the trading of rights are effected in a correct way. This increases the flexibility for content consumers, while protecting the revenue stream for content providers. Possibly, a content provider can charge the customer a fee for the right to trade a purchased content. Thus, by employing the inventive concept, peer to peer exchanges of copyrighted digital content associated with valid digital rights is not a threat to content providers such as, for example, record and motion-picture companies, digital booksellers etc.

According to an embodiment of the present invention, the trading value of a first magnitude is static and represents the value that the associated content commands. When the content provider at a later stage sells a more up-to-date content with an associated digital right for which the market demand is higher, this more recently issued and more desired right will have a higher trading value of a second static magnitude attached to it. This has the effect that the relative trading value of old content decreases in relation to a more recently issued digital content. This is advantageous, since the value of a content and an associated right can be made time dependent, without employing secure and trusted clocks in devices accessing the digital content to decrease the relative value of old, not-so-hot content.

According to a further embodiment of the present invention, the trading value of a first magnitude associated to a content is dynamic and decreases with time. In this embodiment, when the content provider at a later stage sells a more up-to-date content with an associated digital right for which the market demand is higher, this more recently issued and more desired right will have a higher trading value of a second dynamic magnitude attached to it. The dynamic trading values implies that devices accessing the digital content need to comprise clock means for providing a measure of the time elapsed between the issuing of the first and the second digital right in order to alter the magnitude of the first right. Since the trading values are dynamic, it is possible to decrease the magnitude of the first right and/or increase the magnitude of the second right, thus creating a difference in the two trading values. This embodiment also results in the fact that the relative trading value of old content decreases in relation to a more recently issued digital content. Using dynamic trading values has the advantage that the setting of values becomes more flexible as compared with static values, since the magnitudes of the values can be increased or decreased. It is possible not only to elaborate with the values of rights to be issued, but also with the values of rights already issued.

According to another embodiment of the invention, two or more digital rights can be merged, by means of appropriate DRM software, to create a higher trading value for the resulting merged right. This has the advantage that, even though a single right does not command the trading value required to trade the content associated with the single right for another content associated with another higher value right, it is possible to merge multiple rights to create a right having a trading value that equals the total trading value of the rights used in the merger.

According to yet another embodiment of the invention, the first digital right associated with the first digital content can be disassociated from the first digital content and associated with another digital content, if the trading value of the first digital right is equal to or higher than the trading value of the digital right it is to be associated with. This is advantageous, since if two equally valuable contents are to be traded for each other, the concerned users can perform the trade without changing the actual rights, but the contents to which the rights are attached. The received content is thereafter associated with the existing, equally valuable right. Thereby, the users do not have to approach the content provider for the issuing of new rights to be associated with the traded content.

According to another embodiment of the invention, the trading value of the first right is also assigned to the first digital content. This is advantageous, since the right is not tied to the content, but the right and the content can be distributed separately from each other due to the fact that the trading value is assigned to the digital content, thereby creating a means for subsequent association of the right to the content. When a right subsequently is to be associated with a content, the trading value of the right is compared to the trading value of the content to verify that the right is allowed to be associated with the content. If, at the verification, the trading value of the right is equal to or higher than the trading value of the content, the association of the right with the content is allowed. If the trading value of the right is lower than the trading value of the content, the association is not allowed. Thereby, the copyrighted content creator and/or the content provider will not be harmed, since it is not possible to associate a right having a certain trading value with a content having a higher trading value.

According to further embodiments of the invention, a first digital right is assigned a trading value of a first magnitude and is associated with a first digital content. A subsequently issued second digital right is assigned a trading value of a second magnitude and is associated with a second digital content. Assuming that the second digital content is identical with the first digital content and that the rights are issued at the same, or almost the same, point of time, the magnitudes of the trading values will most likely be identical with each other. On the other hand, if some time has elapsed between the issuing of the first and the second digital right, the most recently issued right will most likely command a higher market value, and this should be reflected by the trading value; the higher the demand, the greater the magnitude of the trading value. It is, of course, also possible that the subsequently issued right commands a lower trading value, given that the content it is associated to is less desirable. As to the actual setting of the trading values, there exist a great number alternatives, which is also perceived by a man skilled in the art. The trading value is something that has to be decided by the copyrighted content creator, most likely in cooperation with the content provider.

Further features of, and advantages with, the present invention will become apparent when studying the appended claims and the following description. Those skilled in the art realize that different features of the present invention can be combined to create embodiments other than those described in the following. Many different alterations, modifications and combinations will become apparent for those skilled in the art. The described embodiments are therefore not intended to limit the scope of the invention, as defined by the appended claims.

A detailed description of embodiments of the present invention will be given with reference to the accompanying drawings, in which:

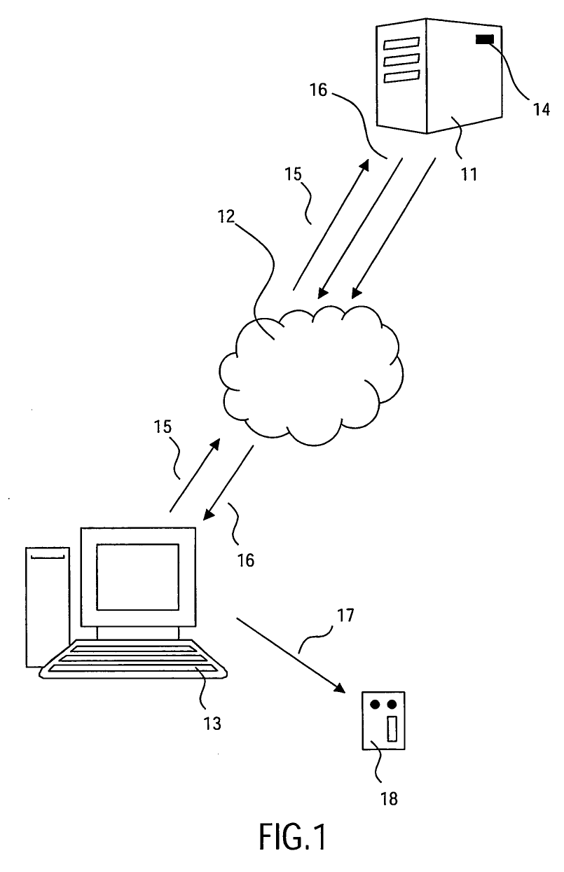

FIG. 1 shows a schematic representation of a system for purchasing digital content and an associated digital right, to which a trading value is assigned, from a content provider and downloading the content and the right to a portable device according to an embodiment of the present invention;

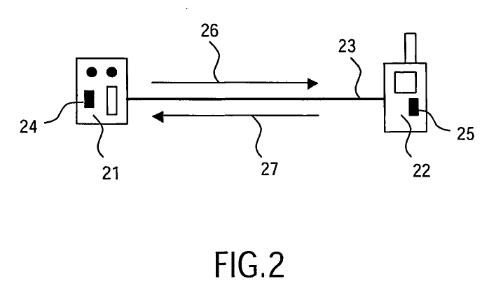

FIG. 2 shows a schematic diagram of trading of digital content according to an embodiment of the present invention; and

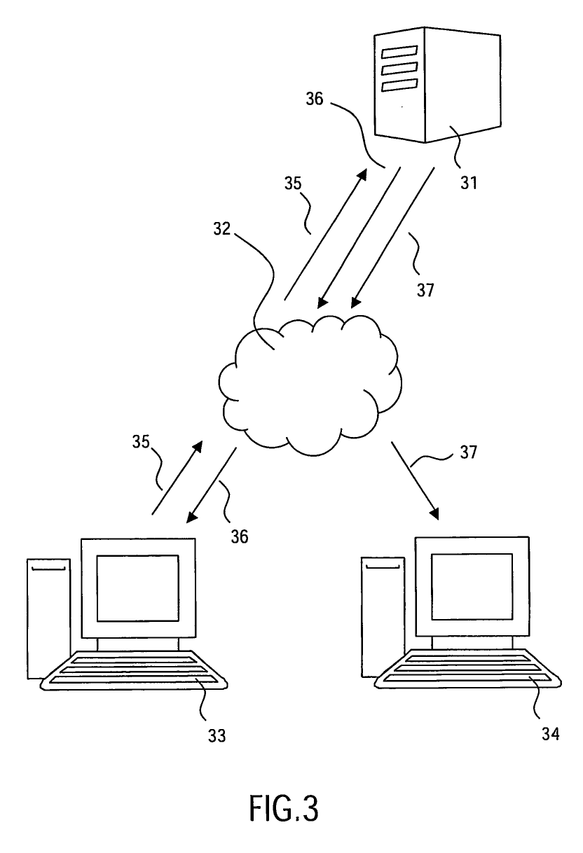

FIG. 3 shows a schematic diagram of digital content trading according to an embodiment of the invention via a trading broker.

FIG. 1 shows a schematic representation of a system for purchasing digital content and an associated digital right, to which a trading value is assigned, from a content provider and downloading the content and the right to a portable device according to an embodiment of the present invention. A server 11 contains some storing means for storing digital content and digital rights associated with the content. In DRM systems, a large number of digital rights exists, for example “play”, “copy”, “burn to CD-R”, “transfer”, “download” etc. In this exemplifying embodiment, for the sake of simplicity, the digital right that is used is “play unlimited”, i.e. if a consumer purchases an audio file from a content provider holding the server 11, the consumer is allowed to play the audio file an unlimited number of times. The type of access given to a proprietor of a digital right is, in this case, consequently “play”. Those skilled in the art will realize that the following reasoning could be applied to virtually any type of access.

DRM systems incorporate more and more different business models which requires that the DRM system is sufficiently flexible to handle many different types of rights. To facilitate the management of the digital rights for participants in DRM systems, rights are expressed using digital rights management languages. It is to be understood that such languages can be employed in the present invention to express digital rights. These languages include ODRL (Open Digital Rights Language) and XrML (extensible Rights Markup Language). DRM languages usually conforms to a standard language notation. ODRL and XrML both allows the rights to be expressed using XML (Extensible Markup Language) notation.

The server 11 is interfaced against a network 12, such as the Internet, via which network 12 a consumer of digital content by means of his/her device with computing capabilities, herein illustrated by computer 13, can purchase content at the server 11 of a content provider. The purchasing is enabled by a software module executed on a microprocessor 14 implemented in the server 11. The consumer logs on at the server 11 from her computer 13 and buys a plurality of audio files (AF1, AF2 and AF3). AF1 is a favorite tune of the consumer, and she pays the standard price for the song. The trading value of the digital right associated with AF 1 is set to zero, as the consumer surely does not want to trade this song later. The consumer is less sure of AF2 and AF3, so she pays a surcharge of 10% for these songs and consequently, the content provider assigns a trading value of, say, 100 to the digital right to be associated with AF2 and AF3 respectively. The consumer performs the purchase transaction 15 by means of her credit card, and the songs and the associated digital rights are transferred 16 from the server 11 of the content provider to the computer 13 of the consumer. The songs and the associated rights are downloaded 17 from the computer 13 to, for example, an MP3 player 18, a mobile phone, an optical disc system complying with the Sapphire secure digital storage standard or the like.

Note that the DRM system employed are implemented in all these devices and controls the transfer and downloading of the content and the rights.

According to an embodiment of the invention, the trading value of 100 is static and represents the value that the associated content commands. When the content provider at a later stage sells a more up-to-date content with an associated digital right for which the market demand is higher, this more recently issued and more desired right will have a higher trading value. For example, assume that the content above, which has a trading value of 100, comprises the latest Janet Jackson album and was bought on the day of its release. A couple of months later, this content is not considered that desirable anymore. However, the new Shakira release has just reached the content providers and this content is much longed-for. The trading value of the Shakira material is given the magnitude 110, which has the effect that the Shakira content is worth more than the Janet Jackson content at a possible trade transaction.

According to another embodiment of the invention, the trading value of 100, representing the value that the associated content commands, is dynamic and decreases with time. In this embodiment, when the content provider at a later stage sells a more up-to-date content with an associated digital right for which the market demand is higher, this more recently issued and more desired right will have a higher trading value. As in the previously described embodiment, the content comprises the latest Janet Jackson album bought on the date of its release and the right associated to the content has a trading value of 100. As time goes by, this content is not considered that desirable anymore, so the trading value of the right is decreased continuously. At the time the new Shakira release reaches the content providers, the trading value of the right associated with the Janet Jackson content has reached 80. The trading value of the Shakira material is given, for example, the magnitude 100, which has the effect that the Shakira content is worth more than the Janet Jackson content at a possible trade transaction.

The dynamic trading values implies that devices accessing the digital content need to comprise clock means, which is the case with microprocessors, for providing a measure of the time elapsed between the issuing of the Janet Jackson right and the issuing of the Shakira right in order to decrease the magnitude of the Janet Jackson right. Since the trading values are dynamic, it is possible to decrease the magnitude of the Janet Jackson right and/or increase the magnitude of the Shakira right, thus creating a difference in the two trading values. Using dynamic trading values has the advantage that the setting of values becomes more flexible as compared with static values, since the magnitudes of the values can be increased or decreased. It is possible not only to elaborate with the values of rights to be issued, but also with the values of rights already issued.

FIG. 2 shows a schematic description of trading of digital content according to an embodiment of the present invention. A consumer has some songs and associated rights stored in her MP3 player 21. Her friend gets to listen to the songs and suggests a trade of a song AF1 stored in the MP3 player 21 for a song AF2 stored in the mobile phone 22 of the friend. A connection 23 is established between the MP3 player 21 and the mobile phone 22. The DRM software executed by a microprocessor 24, 25 implemented in each respective device checks the trading value of the songs and performs a handshake routine. The trading value equals, in this case, 100 for each song. The DRM software of the MP3 player 21 effects the transfer 26 of the song AF1 to the mobile phone 22 and the DRM software of the mobile phone 22 effects the transfer 27 of the song AF2 to the MP3 player 21. The rights which were associated to the old content contained in each respective device is now disassociated from said old content and associated with the new content. It is in this case not necessary to trade rights, since the two rights are identical to each other. The trading 26, 27 of content can take place between any type of devices having computing capabilities in the form of, for example, a microprocessor, an ASIC or some type of programmable logic and the appropriate DRM software implemented. Thus, the devices shown in FIG. 2 could comprise computers, PDAs, portable audio and video players, laptops etc. The connection between the devices can consists of an Internet connection, a wireless connection, an optical connection etc.

According to another embodiment of the present invention described with reference to FIG. 2, two or more digital rights can be merged to create a higher trading value for the resulting merged right. The consumer has two old Janet Jackson songs AF1 and AF2 and associated rights stored in her MP3 player 21. Her friend gets to listen to the songs and suggests a trade of the songs AF1 and AF2 stored in the MP3 player 21 for a new Janet Jackson song AF3 stored in the mobile phone 22 of the friend. A connection 23 is established between the MP3 player 21 and the mobile phone 22. The DRM software executed by a microprocessor 24, 25 implemented in each respective device checks the trading value of the songs and performs a handshake routine. The trading value equals, in this case, 100 for each old song AF1 and AF2, and 200 for the new song AF3. The DRM software of the MP3 player 21 effects the transfer 26 of the songs AF1 and AF2 to the mobile phone 22 and the DRM software of the mobile phone 22 effects the transfer 27 of the song AF3 to the MP3 player 21. The rights, which were associated with the old content contained in each respective device, are now disassociated from said old content and associated with the new content. However, the total trading value of the songs AF1 and AF2 equals 100+100=200 and the value of AF3 equals 200. It is not necessary to trade rights, but the DRM system of the mobile phone 22 will merge the rights associated to AF1 and AF2 and associate the resulting right with the song AF3. The DRM system of the MP3 player 21 will divide the right which was associated with the song AF3 into two equal value rights and associated each right with the songs AF1 and AF2. Alternatively, the two rights each commanding a trading value of 100 is transferred together with the songs AF1 and AF2 from the MP3 player 21 to the mobile phone 22 and the right commanding a trading value of 200 is transferred together with the song AF3 from the mobile phone 22 to the MP3 player 21.

Note that it is possible that authentication may occur between any two, or more, of the devices between which communication takes place in the described embodiments. This would require the distributed information to be provided with some identifier or authenticator, for example in the form of an identification number or some type of encryption or digital signature. Authentication is typically used to improve the security in a system. Optionally, information is encrypted to prevent unauthorized third parties from eavesdropping on an information transfer and accessing/stealing the distributed information. Exactly what security measures that must be taken by a content provider is a trade-off between the cost for implementing security facilities and the risk that the copyrighted content creator and/or the content provider will be harmed. If the digital rights are distributed from a server and stored at computers, the right itself must be copy-protected, as somebody otherwise could copy the right and produce an unlimited amount of digital rights.

FIG. 3 shows a schematic diagram of digital content trading according to an embodiment of the invention via a trading broker. A proprietor of content and associated digital rights logs on, via her computer 33 and a network 32 such as the Internet, to the site of a content provider running the server 31. The proprietor is presented to pages containing contents that the content provider offers for trading and/or purchase, as well as the trading value and/or the price the content commands. The proprietor is offered to open an account at the content provider, whereby the proprietor is offered to transfer 35 and park her content and associated rights at the provider. The proprietor stores her content and associated rights at the server 31, and other users can, by means of the Internet 32 and a computer 34, browse the site associated with the server 31, which allows the proprietor to display her content for the other users. The content provider might provide this service for free, but can also require a commission for providing this service, for example in the form of a premium in connection with the trade of rights or as a flat rate in the form of an annual subscriber fee.

The proprietor might, for example, find some songs on the site that she wants to trade. Suppose she has three songs AF1, AF2 and AF3 with a trading value of 100, 120 and 130, respectively, and finds a brand new song AF4 with a trading value of 330. Since the total trading value of AF1, AF2 and AF3 is 100+120+130=350 and the trading value of AF4 is 330, she will lose 20 units of trading value when trading the right to play AF1, AF2 and AF3 for the right to play AF4. The proprietor is asked whether she accepts the loss of trading value units. If the answer is “yes”, the trade will be effected, and the song AF4 and the associated right will be transferred to the account of the proprietor. The song and the associated right is downloaded 36 to the computer 33 of the proprietor where the playback of the song is performed. A large network of users can be created, among which users trade of copyrighted digital content can be performed. Another user can log on to the site of the content provider running the server 31 and browse the songs the proprietor at the computer 33 offers. Said another user can effect trade of content and download 37 the traded content to his/her computer 34.

The content provider can possibly, assuming that it was the provider that supplied the song AF4 for the songs AF1, AF2 and AF3, remove the second hand songs AF1, AF2 and AF3 from the site, since the provider now “owns” them and their associated rights. This has the effect that the possibility of finding second hand versions of these three songs decreases. If a user cannot find a second hand version of song, the possibility that she will buy a new version of the song directly from the content provider increases.

It should be noted that the above mentioned embodiments exemplify the invention, and that those skilled in the art will be able to design many alternative embodiments without departing from the scope of the appended claims.

1. A method for distribution of digital rights, comprising the steps of:
assigning a first trading value of a first magnitude to a first digital right to be distributed;
assigning a second trading value of a second magnitude to a second digital right;
associating the first digital right with a first digital content, wherein the trading value specifies the value of the first digital when said first digital content is to be traded for another digital content;
associating the second digital right with a second digital content;
distributing the first and second digital rights; and
enabling the first digital content to be traded for the second digital content on the condition that the first trading value meets the second trading value.

2. The method according to claim 1, wherein the magnitudes of the trading values consist of static values.

3. The method according to claim 1, wherein the magnitudes of the trading value consist of dynamic values.

4. The method according to claim 1, wherein two or more digital rights can be merged to create a higher trading value for the resulting merged right.

5. The method according to claim 1, wherein the first digital right associated with the first digital content can be disassociated from the first digital content and associated with another digital content if the trading value of the first digital right is equal to or higher than the trading value of the digital right associated with said another digital right.

6. The method according to claim 1, comprising the step of:
assigning the trading value of the first magnitude to the first digital content.

7. A system for distribution of digital rights, comprising:
means (14) arranged to assign a first trading value of a first magnitude to a first digital right to be distributed;
means (14) arranged to assign a second trading value of a second magnitude to a second digital right;
means (14) arranged to associate the first digital right with a first digital content, wherein the trading value specifies the value of the first digital when said first digital content is to be traded for another digital content;
means (14) arranged to associate the second digital right with a second digital content;
means (14) arranged to distribute the first and second digital rights; and
means for enabling the first digital content to be traded for the second digital content on the condition that the first trading value meets the second trading value.

8. The system according to claim 7, wherein the magnitudes of the trading values consist of static values.

9. The system according to claim 7, wherein the magnitudes of the trading value consist of dynamic values.

10. The system according to claim 7, comprising:
means (14) arranged to merge two or more digital rights to create a higher trading value for the resulting merged right.

11. The system according to claim 7, comprising:
means (14) arranged to disassociate the first digital right associated with the first digital content and associate the first digital right with another digital content, if the trading value of the first digital right is equal to or higher than the trading value of the digital right associated with said another digital right.

12. The system according to claim 7, comprising:
means (14) arranged to assign the trading value of the first magnitude to the first digital content.

13. A computer-readable medium storing computer-executable components for causing a unit (11) to perform the steps recited in claim 1 when the computer-executable components are run on a microprocessor (14) included by the unit (11).
